(19) United States
(12) Patent Application Publication
(10) Pub. No.: US 2002/0061754 A1
(43) Pub. Date: May 23, 2002

(54) Mobile communication terminal and operation control system thereof

(75) Inventor: Yoshiyuki Takano, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/992,646

(22) Filed: Nov. 14, 2001

(30) Foreign Application Priority Data
Nov. 22, 2000 (JP) 355854/2000

(51) Int. Cl. H04Q 7/20

(52) U.S. Cl. 455/456; 455/419; 455/414

(57) ABSTRACT

A mobile communication terminal and an operation control system of mobile communication terminals, in which its operation setting is changed suitably, are provided. The mobile communication terminal provides a GPS receiver and measures the exact position of its own terminal by receiving signals from GPS satellites. And the mobile communication terminal registers plural operation settings corresponding to addresses, and also a management center registers plural operation settings corresponding to addresses. When the mobile communication terminal moves from a first address to a second address, the mobile communication terminal measures its own position and transmits the measure position to a management center via a base station. The management center transmits the information of the second address and its operation setting to the mobile communication terminal via the base station, when the mobile communication terminal does not have the operation setting in its own terminal. The mobile communication terminal receives the information of the second address and the operation setting from the management center via the base station, and sets its operation setting corresponding to the received information by choosing either the normal setting or the received operation setting. With this, the operation setting can be set automatically or semi-automatically corresponding to the position change of the mobile communication terminal. Therefore, it can be prevented that the user of the mobile communication terminal forgets to change its operation setting, and also the bother changing the operation setting for the user can be removed.

### BACKGROUND OF THE INVENTION

The present invention relates to a mobile communication terminal and an operation control system of mobile communication terminals, in particular, in which an operation setting of each of the mobile communication terminals is changed suitably corresponding to the address positioned each of the mobile communication terminals.

### DESCRIPTION OF THE RELATED ART

At a conventional mobile communication terminal and a conventional operation control system of mobile communication terminals, for example, their operation settings are chosen based on their present addresses.

Recently, the mobile communication terminals have increased rapidly, and the quality of service at the mobile communication system has improved, and areas where its service is not available have hardly existed. The convenience, which everyone can use the mobile communication terminal everywhere, has increased, however, on the contrary, some measures, which prevent damages caused by radio waves and ringing tones generated by the mobile communication terminals, have been largely required. Consequently, at the places and surroundings where these damages must be decreased, users of the mobile communication terminals have been required to act quickly for switching off the power supply or stopping the ringing tones of the mobile communication terminals.

Japanese Patent Application Laid-Open No. HEI 11-18159 discloses “Mobile Communication Terminal with GPS Apparatus”. At this application, receiving and transmitting functions of a mobile communication terminal are automatically controlled under specific surroundings, based on the present position information, the moving speed information, the map information, and the surroundings information of the mobile communication terminal. With this, the receiving and transmitting functions of the mobile communication terminal are unconditionally controlled, while the user is driving a car, or when the user is in some facilities, where the user has to refrain from using the mobile communication terminal, such as hospitals and galleries. And the occurrence of traffic accidents and the malfunction of instruments in the hospitals are prevented by this control.

At the conventional technology mentioned above, a map information memory is provided, and transmitting and receiving prohibiting area information is stored in the map information memory. And also its transmitting and receiving functions of the mobile communication terminal are controlled by detecting a moving speed of the mobile communication terminal while the user is driving a car. However, in this application, any method to store the transmitting and receiving prohibiting area information is not described.

And at another conventional technology, when the user does not understand these specific places and surroundings, and even when the user understands them, in some cases, the user does not change its operation setting, because it is bothersome for the user to change its operation setting, or the user forgets to change the operation setting. And it is actual that the user does not change its operation setting suitably. And an announcement or a sign at these specific places to urge the user to change its operation setting is generated anywhere and anytime, therefore, there is a case that the announcement or the sign gives uncomfortable feeling to persons who are not using a mobile communication terminal or changed their operation setting suitably.

Moreover, at the conventional technology, there is a problem that the user must judge almost all of the specific places and surroundings where the user must change the operation setting of the mobile communication terminal. And further there is a problem that a suitable method, which requests only the user to change its operation setting, is not provided.

### SUMMARY OF THE INVENTION

It is therefore an object of the present invention to provide a mobile communication terminal and an operation control system of mobile communication terminals, in which its operation setting can be changed suitably at the places and surroundings where the operation setting must be changed.

According to a first aspect of the present invention for achieving the object mentioned above, there is provided a mobile communication terminal. The mobile communication terminal provides a GPS receiver that measures the exact position (latitude and longitude) of the mobile communication terminal by receiving signals from GPS satellites, an operation setting section that registers plural operation settings corresponding to addresses, and an operation setting receiver that receives the information of an operation setting corresponding to the address of the exact position of the mobile communication terminal from a management center in which operation settings corresponding to addresses are registered, via a base station. And in case that the mobile communication terminal moved to an address, the mobile communication terminal changes its operation setting corresponding to the moved address by retrieving the registered plural operation settings in its own terminal when the operation setting at the moved address exists in its own terminal. And when the operation setting does not exists in the own terminal and exits in the management center, the mobile communication terminal changes its operation setting corresponding to the moved address by receiving from the management center via the base station, by that the management center retrieves the plural operation settings registering in the management center. And when the operation setting at the moved address does not exist both in the own terminal and the management center, the operation setting is returned to a normal setting (initial setting) of the mobile communication terminal.

According to a second aspect of the present invention, there is provided an operation control system of mobile communication terminals. The operation control system of the mobile communication terminals provides mobile communication terminals, base stations, and a management center. And each of the mobile communication terminals provides a GPS receiver that measures the exact position (latitude and longitude) of the mobile communication terminal by receiving signals from GPS satellites, an operation setting section that registers plural operation settings corresponding to addresses, and an operation setting receiver that receives the information of an operation setting corresponding to the address of the exact position of the mobile communication terminal from a management center in which operation settings corresponding to addresses are registered, via a base station. And the management center receives the information of the measured positions of the mobile communication terminals via the base stations and manages the operation settings of addresses corresponding to the measured positions, and transmits an operation setting required by one of the mobile communication terminals to the mobile communication terminal.

According to a third aspect of the present invention in the second aspect, the operation settings corresponding to specific addresses are registered beforehand in the management center.

According to a fourth aspect of the present invention in the second aspect, the mobile communication terminal inquires the management center of the operation setting of the address positioning the mobile communication terminal via the base station in a designated time interval.

According to a fifth aspect of the present invention, in the second aspect, the management center retrieves an address based on the position information informed from the mobile communication terminal via the base station and retrieves an operation setting corresponding to the retrieved address, and informs the mobile communication terminal about the information of the retrieved operation setting via the base station.

According to a sixth aspect of the present invention, in the second aspect, the each of the mobile communication terminals, further provides an operation setting choosing section that decides whether the mobile communication terminal changes the operation setting or not, in case right after the mobile communication terminal switched on its power supply, or in case that the received address is different from an address received right before.

According to a seventh aspect of the present invention in the sixth aspect, the mobile communication terminal changes its operation setting to an operation setting registered beforehand in the management center or in the mobile communication terminal itself, or a normal setting being an initial setting, after the mobile communication terminal chose the change of the operation setting.

### BRIEF DESCRIPTION OF THE DRAWINGS

The objects and features of the present invention will become more apparent from the consideration of the following detailed description taken in conjunction with the accompanying drawings in which:

FIG. 1 is a diagram showing a structure of an operation control system of mobile communication terminals at embodiments of the present invention;

FIG. 2 is a flowchart showing an operation at the time when the power supply of a mobile communication terminal is switched on at the embodiments of the present invention;

FIG. 3 is a flowchart showing an operation executing operation settings of the mobile communication terminal at a first embodiment of the operation control system of the mobile communication terminals of the present invention; and

FIG. 4 is a flowchart showing an operation of a subroutine using at the step S212 in FIG. 3 at a second embodiment of the operation control system of the mobile communication terminals of the present invention.

### DESCRIPTION OF THE PREFERRED EMBODIMENTS

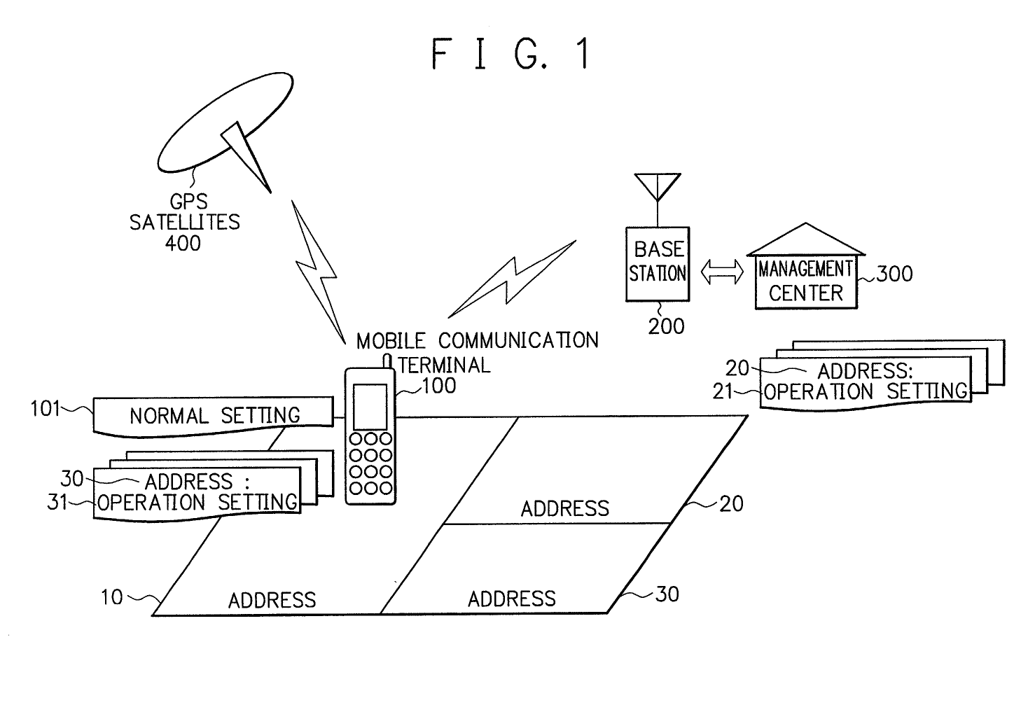

Referring now to the drawings, embodiments of the present invention are explained in detail. FIG. 1 is a diagram showing a structure of an operation control system of mobile communication terminals at embodiments of the present invention. As shown in FIG. 1, the operation control system of the mobile communication terminals at the embodiments of the present invention consists of a mobile communication terminal 100, a base station 200, a management center 300, and global positioning system (GPS) satellites 400. In this, actually, plural mobile communication terminals 100, and plural base stations 200, exist, however, to make the explanation concise, the embodiments of the present invention are explained by using one each.

At the embodiments of the present invention, the position of the mobile communication terminal 100, measured by using the GPS satellites 400, is converted into an address, and its operation setting, such as stopping the power supply and ringing tone of the mobile communication terminal 100, is changed almost automatically, corresponding to the address.

The mobile communication terminal 100 provides a GPS receiver and measures the exact position (latitude and longitude) of its own terminal by receiving signals from the GPS satellites 400, and informs the base station 200 about the position information of the mobile communication terminal 100. And also the mobile communication terminal 100 receives the information of an operation setting at the address of the mobile communication terminal 100 from the base station 200, and monitors the address positioned its own terminal by comparing the present address with the address being right before, and detects its changed address. In this, the operation settings at the addresses of specific places has been registered in the management center 300, and the mobile communication terminal 100 receives the operation setting at the moved address from the base station 200 via the management center 300, when the operation setting at the moved address has not been registered in the mobile communication terminal 100. And in case that the operation setting at the moved address has already been registered in the mobile communication terminal 100, the mobile communication terminal 100 changes its won operation setting corresponding to the operation setting at the moved address. In case that the operation setting at the moved address has not been registered yet in both the mobile communication terminal 100 and the management center 300, the operation setting is returned to a normal setting 101 as shown in FIG. 1.

The base station 200 inquires the management center 300 of the address and its operation setting at the position where the mobile communication terminal 100 exists. After the base station 200 received the information of the address and its operation setting from the management center 300, the base station 200 transmits the information to the mobile communication terminal 100.

The management center 300 retrieves the address and its operation setting for the inquiry concerning the mobile communication terminal 100 from the base station 200, and informs the base station 200 of the retrieved result. In case that the operation setting has been registered in the management center 300, the management center 300 informs the base station 200 about the address and its operation setting. In case that the operation setting has not been registered yet in the management center 300, the management center 300 informs the base station 200 about only the address. The GPS satellites 400 transmit signals of the GPS to the mobile communication terminal 100.

Next, referring to drawings, an operation at a first embodiment of the operation control system of the mobile communication terminals of the present invention is explained. As shown in FIG. 1, at the operation of the embodiments of the operation control system of the mobile communication terminals of the present invention, a first address 10, a second address 20, and a third address 30 are shown. And it is assumed that an operation setting 21 has been registered at the second address 20 in the management center 300, and an operation setting 31 has been registered at the third address 30 in the mobile communication terminal 100. And at the first address 10, its operation setting has not been set.

As mentioned above, in FIG. 1, the mobile communication terminal 100 measures its own exact position by using signals from the GPS satellites 400, and transmits its measured position information to the base station 200. The base station 200 inquires whether the management center 300 stores the address of the position of the mobile communication terminal 100 and the operation setting at the address based on the received position information. The management center 300 converts the received position information into an address, and retrieves the operation setting at the address. And the management center 300 informs the base station 200 about the information of the address or both the address and the operation setting at the address.

The base station 200 transmits the information from the management center 300 to the mobile communication terminal 100. The mobile communication terminal 100 judges the movement of the address based on the received information, and changes its own operation setting when the movement occurred. In this, in case that the operation setting at the moved address was received from the management center 300 via the base station 200 or has been already registered in the mobile communication terminal 100, the mobile communication terminal 100 changes its operation setting to the operation setting at the moved address. However, in case that the operation setting at the moved address does not exist, the mobile communication terminal returns the operation setting to the normal setting (initial setting). The operation setting at each address is registered beforehand to the management center 300 by a person in the address or a person who manages its specific place. And the normal setting and operation settings to each mobile communication terminal 100 are registered beforehand by the user of the mobile communication terminal 100.

In this, the mobile communication terminal 100 is a radio telephone set such as a cellular phone and a terminal at the personal handy-phone system (PHS) with a GPS receiver. And the operation setting is a combination of a switching off state of a mobile communication terminal and one of informing methods such as generating vibration, generating sound, and displaying letters, at an address. And plural operation settings can be registered in the management center 300 and the mobile communication terminal 100. The normal setting is an operation setting that is used at the time when a mobile communication terminal uses its transmitting and receiving functions, in case that the operation settings have not been registered yet when a user of the mobile communication terminal uses the operation control system of the present invention. Or the normal setting is used in case that the operation control system of the present invention is not used. And also the normal setting is a combination of the transmitting and receiving functions of the mobile communication terminal and one of informing methods such as generating vibration, generating sound, and displaying letters, and only one normal setting can be registered in the mobile communication terminal 100.

The mobile communication terminal 100 provides a setting function, which decides whether the mobile communication terminal 100 changes its operation setting or not corresponding to each address. And at the initial stage, the setting function sets to that the mobile communication terminal 100 changes its operation setting.

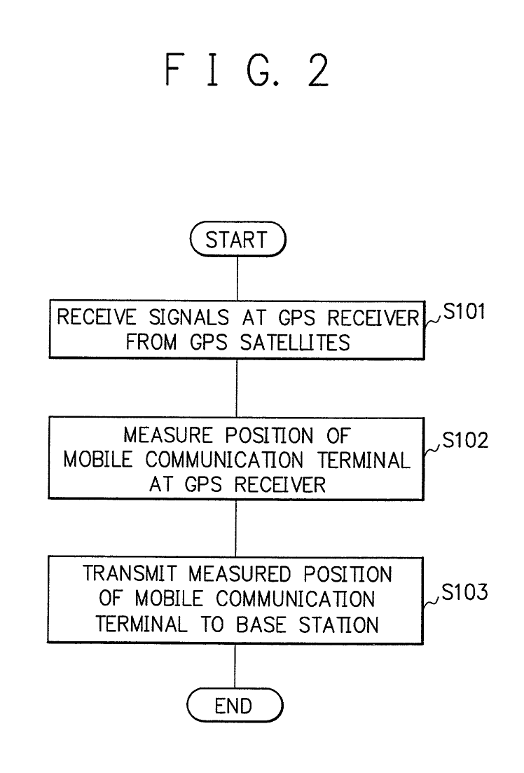

FIG. 2 is a flowchart showing an operation at the time when the power supply of the mobile communication terminal 100 was switched on at the embodiments of the present invention. Referring to FIGS. 1 and 2, first, the operation at the time when the power supply of the mobile communication terminal 100 was switched on at the embodiments of the present invention is explained.

First, the power supply of the mobile communication terminal 100 was switched on at the first address 10 and receives signals from the GPS satellites 400 at the GPS receiver in the mobile communication terminal 100 (step S101). The GPS receiver measures its own position of the mobile communication terminal 100 (step S102), and transmits the information of the measured position of the mobile communication terminal 100 to the base station 200 (step S103). The base station 200 transmits the position information of the mobile communication terminal 100 to the management center 300.

The management center 300 detects that the position information was received from the first address 10 and any operation setting has not been registered yet at this first address 10, and transmits only the address information of the first address 10 to the base station 200.

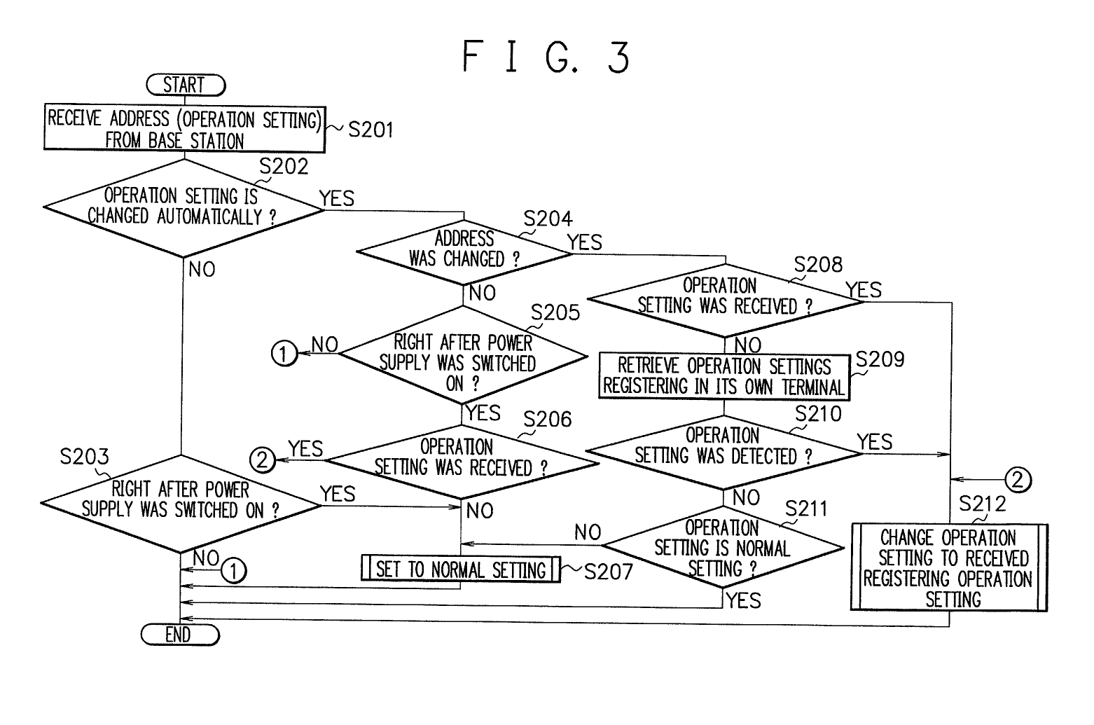

FIG. 3 is a flowchart showing an operation executing operation settings of the mobile communication terminal 100 at a first embodiment of the operation control system of the mobile communication terminals of the present invention. Referring to FIGS. 1 and 3, the operation executing the operation settings of the mobile communication terminal 100 at the first embodiment of the present invention is explained.

In FIG. 3, the base station 200 transmits the information received from the management center 300 to the mobile communication terminal 100, and the mobile communication terminal 100 receives only the address information of the first address 10 (step S201). The mobile communication terminal 100 is in a state that it automatically changes its operation setting corresponding to the received address information (YES at step S202), and it is judged whether its address was changed or not (step S204). In this case, the mobile communication terminal 100 did not move and stays in the address 10 (NO at the step S204). And the mobile communication terminal 100 is right after its power supply was switched on (YES at step S205). And also the mobile communication terminal 100 did not receive an operation setting (received only the address information) (NO at step S206), therefore the mobile communication terminal 100 is set to be its normal setting 101 (step S207), that is, the mobile communication terminal 100 stays in the normal setting.

Next, an operation, at the time when the mobile communication terminal 100 moved to an address where an operation setting has been registered, is explained. It is assumed that the mobile communication terminal 100 moved from the first address 10 to the second address 20. As mentioned above, the mobile communication terminal 100 measures its own position and transmits the measured position information to the management center 300 via the base station 200. The management center 300 detects that the position of the mobile communication terminal 100 is in the second address 20, and also detects that the operation setting 21 has been registered at the second address 20. And the management center 300 transmits the information of the second address 20 and its operation setting 21 to the mobile communication terminal 100 via the base station 200.

Next referring to FIGS. 1 and 3, this operation is explained in detail. First, the mobile communication terminal 100 receives the information of the second address 20 and the operation setting 21 from the base station 200 (step S201). The mobile communication terminal 100 is in a state that it automatically changes its operation setting corresponding to the received address information (YES at step S202), and it is judged whether the address was changed or not (step S204). In this case, the mobile communication terminal 100 moved from the first address 10 to the second address 20 (YES at the step S204) and also received the information of the operation setting 21 (YES at step S208). Therefore, the mobile communication terminal 100 is set to be the operation setting 21 (step S212).

Next, an operation, at the time when the mobile communication terminal 100 moved from an address where an operation setting has been registered to an address where an operation setting has not been registered, is explained. It is assumed that the mobile communication terminal 100 moved from the third address 30 to the first address 10. As mentioned above, the mobile communication terminal 100 measures its own position and transmits the position information to the management center 300 via the base station 200. The management center 300 detects that the position of the mobile communication terminal 100 is in the first address 10, and also detects that any operation setting has not been registered at the first address 10. And the management center 300 transmits only the information of the first address 10 to the mobile communication terminal 100 via the base station 200.

Next referring to FIGS. 1 and 3, this operation is explained in detail. First, the mobile communication terminal 100 receives the information of only the first address 10 from the base station 200 (step S201). The mobile communication terminal 100 is in a state that it automatically changes its operation setting corresponding to the received address information (YES at step S202), and it is judged whether the address was changed or not (step S204). In this case, the mobile communication terminal 100 moved from the third address 30 to the first address 10 (YES at the step S204) and has not received the information of the operation setting (NO at step S208). And the mobile communication terminal 100 retrieves operation settings registering in its own mobile communication terminal 100 (step S209). But the operation setting for the information of the first address 10 has not been registered in the mobile communication terminal 100, and the mobile communication terminal 100 could not detect the operation setting in its own terminal (NO at step S210). And the operation setting is the operation setting 31 and not the normal setting 101 (NO at step S211). Therefore, the mobile communication terminal 100 sets it operation setting to the normal setting 101 (step S207).

As mentioned above, according to the first embodiment of the present invention, the operation setting of the mobile communication terminal 100 can be changed automatically corresponding to the change of the position of the mobile communication terminal 100. Therefore, it can be prevented that the user of the mobile communication terminal 100 forgets to change its operation setting, and also the bother changing the operation setting for the user can be removed.

Further, according to the first embodiment of the present invention, operation settings being suitable for various places can be automatically informed to persons who are unconcerned about the influence to others, caused by the operation of the mobile communication terminals, by generating vibration, generating sound, or displaying letters, without using an announcement or a sign at those places. And also these suitable operation settings can be automatically informed to persons who do not understand places where the operation of the mobile communication terminals is limited, by the same methods mentioned above, without using the announcement or the sign at those places. Therefore, the necessity of the announcement and the sign to make those persons change their operation settings is decreased, and the announcement and the display can be decreased.

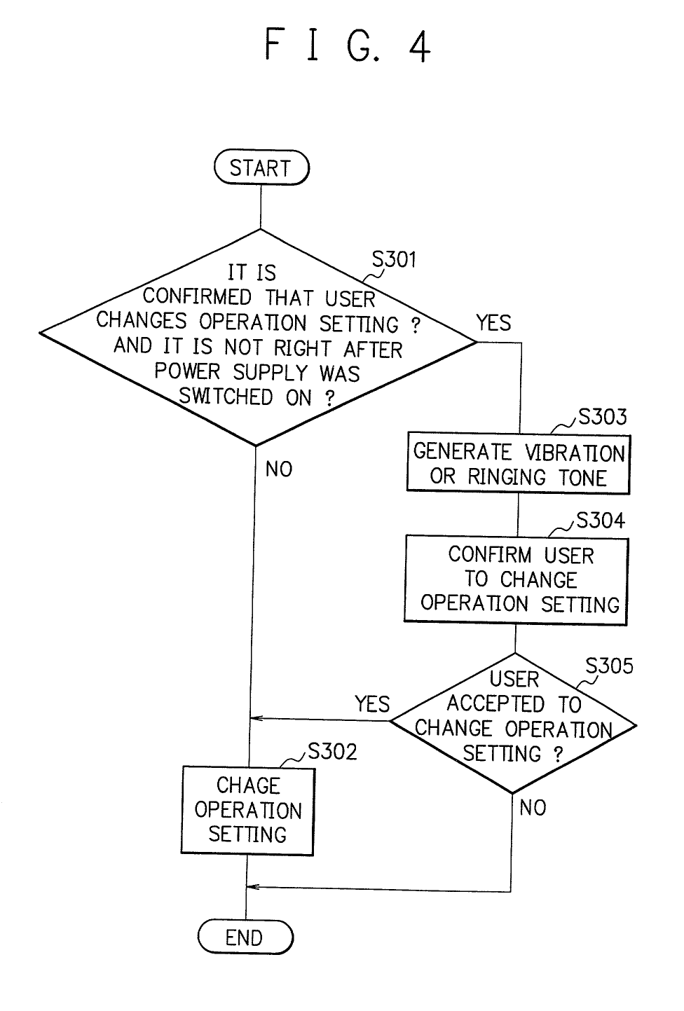

Next, a second embodiment of the operation control system of the mobile communication terminals of the present invention is explained. FIG. 4 is a flowchart showing an operation of a subroutine using at the step S212 in FIG. 3 at the second embodiment of the operation control system of the mobile communication terminals of the present invention. That is, at the second embodiment, the subroutine shown in FIG. 4 is applied to the step S212 shown in FIG.3 at the first embodiment.

Referring to FIGS. 1, 3, and 4, the second embodiment of the operation control system of the mobile communication terminals of the present invention is explained.

At the second embodiment of the present invention, when a user of a mobile communication terminal 100 moves from a first address 10 where its operation setting has not been registered to a second address 20 where its operation setting 21 has been registered, the user of the mobile communication terminal 100 refuses that its operation setting is changed to the operation setting 21. This is different from the first embodiment. Therefore, the mobile communication terminal 100 has a function that confirms whether the user changes the operation setting or not before changing its operation setting corresponding to the address, and the user can refuse to change the operation setting.

It is assumed that the mobile communication terminal 100 moved from the first address 10 to the second address 20. The mobile communication terminal 100 measures its own position and transmits the measured position information to the management center 300 via the base station 200. The management center 300 transmits the information of the second address 20 and the operation setting 21 to the mobile communication terminal 100 via the base station 200.

The mobile communication terminal 100 receives the information of the second address 20 and the operation setting 21 from the management center 300 via the base station 200 (step S201). After the steps S202, S204, and S208, the mobile communication terminal 100 tries to change its operation setting to the operation setting 21 based on the received information (the step S212).

At this step S212, the subroutine shown in FIG. 4 is applied. The mobile communication terminal 100 confirms that the user changes the operation setting caused by that the mobile communication terminal 100 moved (YES at step S301). And the mobile communication terminal 100 informs the user about that the mobile communication terminal 100 moved to an address where an operation setting has been registered by using its ringing tone or its vibration function (step S303).

Next, the mobile communication terminal 100 confirms that the user changes its operation setting to the operation setting 21 at the second address 20 by displaying letters on its display or generating its ringing tone (step S304). When the user refused to change the operation setting (NO at step S305), the mobile communication terminal 100 does not change its operation setting to the operation setting 21.

When the user accepted to change the operation setting (YES at the step S305), the mobile communication terminal 100 changes its operation setting (step S302). Consequently, the mobile communication terminal 100 returns to the same operating state at the first embodiment.

As mentioned above, at the second embodiment, even when the mobile communication terminal 100 is set to be a state that the operation setting is changed corresponding to that the address is changed, the user can confirm whether the operation setting is changed or not. Consequently, the user can refuse to change the operation setting, therefore it can be prevented that the user is forced to obey the registering operation setting unconditionally.

As clearly mentioned above, according to the present invention, a mobile communication terminal of the present invention measures its exact position (latitude and longitude) by using signals from GPS satellites. And the mobile communication terminal registers plural operation settings corresponding to addresses. And the mobile communication terminal receives the information of an operation setting corresponding to the address of the mobile communication terminal from a management center in which plural operation settings of addresses are registered beforehand, when its operation setting has not been registered in the mobile communication terminal. Therefore the mobile communication terminal can change its operation setting automatically corresponding to the change of the position of the mobile communication terminal. With this, it is prevented that the user forgets to change its operation setting, and also the bother to change the operation setting for the user can be removed.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A mobile communication terminal, comprising:
a GPS receiver that measures the exact position (latitude and longitude) of said mobile communication terminal by receiving signals from GPS satellites;
an operation setting section that registers plural operation settings corresponding to addresses; and
an operation setting receiver that receives the information of an operation setting corresponding to the address of said exact position of said mobile communication terminal from a management center in which operation settings corresponding to addresses are registered, via a base station, wherein:
in case that said mobile communication terminal moved to an address, said mobile communication terminal changes its operation setting corresponding to the moved address by retrieving said registered plural operation settings in its own terminal when said operation setting at the moved address exists in its own terminal, and
when said operation setting does not exists in said own terminal and exits in said management center, said mobile communication terminal changes its operation setting corresponding to the moved address by receiving from said management center via said base station, by that said management center retrieves said plural operation settings registering in said management center, and
when said operation setting at the moved address does not exist both in said own terminal and said management center, said operation setting is returned to a normal setting (initial setting) of said mobile communication terminal.

2. An operation control system of mobile communication terminals, comprising:
mobile communication terminals;
base stations; and
a management center, wherein:
each of said mobile communication terminals, comprising:
a GPS receiver that measures the exact position (latitude and longitude) of said mobile communication terminal by receiving signals from GPS satellites;
an operation setting section that registers plural operation settings corresponding to addresses; and
an operation setting receiver that receives the information of an operation setting corresponding to the address of said exact position of said mobile communication terminal from a management center in which operation settings corresponding to addresses are registered, via a base station and
said management center receives the information of said measured positions of said mobile communication terminals via said base stations and manages said operation settings of addresses corresponding to said measured positions, and transmits an operation setting required by one of said mobile communication terminals to said mobile communication terminal.

3. An operation control system of mobile communication terminals in accordance with claim 2, wherein:
said operation settings corresponding to specific addresses are registered beforehand in said management center.

4. An operation control system of mobile communication terminals in accordance with claim 2, wherein:
said mobile communication terminal inquires said management center of said operation setting of said address positioning said mobile communication terminal via said base station in a designated time interval.

5. An operation control system of mobile communication terminals in accordance with claim 2, wherein:
said management center retrieves an address based on said position information informed from said mobile communication terminal via said base station and retrieves an operation setting corresponding to said retrieved address, and informs said mobile communication terminal about the information of said retrieved operation setting via said base station.

6. An operation control system of mobile communication terminals in accordance with claim 2, wherein:
each of said mobile communication terminals, further comprising:
an operation setting choosing section that decides whether said mobile communication terminal changes said operation setting or not, in case right after said mobile communication terminal switched on its power supply, or in case that said received address is different from an address received right before.

7. An operation control system of mobile communication terminals in accordance with claim 6, wherein:
said mobile communication terminal changes its operation setting to an operation setting registered beforehand in said management center or in said mobile communication terminal itself, or a normal setting being an initial setting, after said mobile communication terminal chose said change of said operation setting.
